(19) United States
(12) Patent Application Publication
(10) Pub. No.: US 2025/0367614 A1
(43) Pub. Date: Dec. 4, 2025

(54) MIXER APPARATUS FOR FLUID MIXING

(71) Applicant: HED SYSTEMS, LLC, Charlotte, NC (US)

(72) Inventors: Bruce E. Nadeau, JR., Charlotte, NC (US); Joseph C. Lull, South Haven, MI (US)

(73) Assignee: HED SYSTEMS, LLC, Charlotte, NC (US)

(21) Appl. No.: 18/679,139

(22) Filed: May 30, 2024

(51) Int. Cl. B01F 25/314; B01F 25/00; B01F 25/4314

(52) U.S. Cl. CPC B01F 25/31423; B01F 25/3141; B01F 25/4314; B01F 2025/913; B01F 2025/915

(57) ABSTRACT

A fluid mixer apparatus can include an annular ring defining a fluid flow path configured for a first fluid through the annular ring. The annular ring can include one or more fluid inlets circumferentially disposed on an exterior surface of the annular ring, the one or more fluid inlets configured to receive a second fluid different than the first fluid. The fluid mixer apparatus can include a central hub and a plurality of helical airfoils positioned inside the annular ring and connected to both of the annular ring and the central hub. In some examples, each helical airfoil of the plurality of helical airfoils can include: a plurality of perforations in fluid communication with the one or more fluid inlets to introduce the first fluid into the second fluid; and an airfoil surface perturbation positioned adjacent to or rearward of the plurality of perforations.

### FIELD

The described examples relate generally to mixing fluids.

### BACKGROUND

Fluids of all types are commonly delivered or transported in a variety of ways. Often, fluids are treated at some point in the delivery or transportation process (e.g., to facilitate subsequent refinement processes, storage, use, sale, or production). Treatment can include, for example, chemical treatment to remove, inoculate, dissolve, bind with, sanitize, purify, or alter certain fluid elements or fluid properties. For instance, treatment of water can include “hard” water treatment to remove certain minerals from the water and/or water purification treatment to eliminate at least a threshold amount of viruses and bacteria. As another example, iron distressed oil (e.g., with excess iron content) can undergo iron chelate treatment to reduce iron levels in the crude oil. These and other conventional treatment processes can be expensive, time consuming, and inefficient. Common iron chelate treatment, for instance, can often entail 10-12 hours of treatment, including agitation steps, decant steps, testing, etc. Therefore, there is an ongoing need for improved systems, apparatuses, and methods of mixing fluids, including in applications for fluid treatment.

The subject matter claimed herein is not limited to examples that solve any disadvantages or that operate only in environments such as those described above. Rather, this background is only provided to illustrate one example technology area where some examples described herein may be practiced.

### SUMMARY

An aspect of the present disclosure relates to a fluid mixer apparatus. The fluid mixer apparatus can include: an annular ring defining a fluid flow path configured for a first fluid through the annular ring, the annular ring including one or more fluid inlets circumferentially disposed on an exterior surface of the annular ring, and the one or more fluid inlets configured to receive a second fluid different than the first fluid; a central hub; and a plurality of helical airfoils positioned inside the annular ring and connected to both of the annular ring and the central hub. In some examples, each helical airfoil of the plurality of helical airfoils can include: a plurality of perforations in fluid communication with the one or more fluid inlets to introduce the first fluid into the second fluid; and an airfoil surface perturbation positioned adjacent to or rearward of the plurality of perforations.

In some examples, the airfoil surface perturbation includes a wavelet. In at least one example, the wavelet extends from an inboard portion of the helical airfoil to an outboard portion of the helical airfoil. In particular examples, the plurality of perforations extends along a length of the wavelet. In certain examples, the wavelet is a first wavelet, and the airfoil surface perturbation includes a second wavelet rearward of the first wavelet. In one or more examples, the airfoil surface perturbation includes a plurality of serrations along a trailing edge of the helical airfoil. In some examples, the plurality of serrations includes finger portions configured in alternating orientations relative to the trailing edge. In certain implementations, the plurality of serrations includes at least one of different serration lengths or different serration angles along the trailing edge between an inboard portion of the helical airfoil and an outboard portion of the helical airfoil.

Another aspect of the present disclosure relates to a stationary mixing device for mixing fluids. The stationary mixing device can include: a housing including one or more fluid inlets disposed on an exterior surface of the housing; and a plurality of airfoils affixed to the housing. In some examples, each airfoil of the plurality of airfoils includes: a leading edge; a trailing edge positioned opposite of the leading edge; and a top surface and a bottom surface opposite the top surface. In one or more examples, the top surface and the bottom surface extend between the leading edge and the trailing edge; and a fluid is configured to split at the leading edge such that a first fluid portion flows across the top surface at a first velocity and a second fluid portion is configured to flow across the bottom surface at a second velocity slower than the first velocity. In some examples, a plurality of perforations can be defined by the top surface, the plurality of perforations being in fluid communication with the one or more fluid inlets.

In one or more examples, the stationary mixing device further includes an airfoil surface perturbation positioned adjacent to or rearward of the plurality of perforations. In some examples, the airfoil surface perturbation is a first airfoil surface perturbation positioned on the top surface; and each airfoil of the plurality of airfoils includes a second airfoil surface perturbation positioned along the trailing edge. In certain examples, the first airfoil surface perturbation is configured to induce a first mixing event before the trailing edge; and the second airfoil surface perturbation is configured to induce a second mixing event after the trailing edge. In particular examples, each airfoil of the plurality of airfoils includes an interior portion defining a cavity in fluid communication with the one or more fluid inlets and the plurality of perforations. In some examples, the cavity is configured to be pressurized at a pressure that is greater than a fluid pressure at the top surface of the airfoil.

Yet another aspect of the present disclosure relates to a fluid mixer apparatus. The fluid mixer apparatus can include: a housing including a plurality of fluid inlets disposed on an exterior surface of the housing; and a plurality of airfoils affixed to the housing. In some examples, each airfoil of the plurality of airfoils can include: a major surface defining a plurality of perforations in fluid communication with the plurality of fluid inlets; a wavelet positioned on the major surface and adjacent to the plurality of perforations; and a trailing edge contiguous to the major surface, the trailing edge including a plurality of serrations.

In some examples, the wavelet is configured to induce fluid recursion leading into the plurality of serrations. In particular examples, the plurality of serrations is configured to cause interacting vortices. In one or more examples, the wavelet is a first wavelet, and a series of wavelets is positioned behind the first wavelet. In certain implementations, each serration of the plurality of serrations is pitched out-of-plane relative to the trailing edge. In at least one example, the exterior surface defines an injection cavity positioned adjacent to the plurality of fluid inlets, the injection cavity separated from the plurality of fluid inlets by slotted ribs.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1-2 illustrate an example environment of a mixer apparatus in accordance with one or more examples of the present disclosure;

FIG. 3-8 respectively illustrate front perspective, rear perspective, front, rear, top, and side perspective views of an example mixer device in accordance with one or more examples of the present disclosure;

FIGS. 9-12 illustrate various cross-sectional views of the example mixer device of FIGS. 3-7, in accordance with one or more examples of the present disclosure;

FIG. 13 illustrates an example airfoil of a mixer device in accordance with one or more examples of the present disclosure;

FIGS. 14-15 illustrate another example airfoil of a mixer device in accordance with one or more examples of the present disclosure;

FIGS. 16-20 respectively illustrate front perspective, rear perspective, side perspective, and various cross-sectional views of another example mixer device in accordance with one or more examples of the present disclosure;

FIGS. 21-22 respectively illustrate front perspective and rear perspective views of yet another example mixer device in accordance with one or more examples of the present disclosure;

FIG. 23 illustrates an example mixer device in accordance with one or more examples of the present disclosure; and

FIGS. 24-26 respectively illustrate front perspective, rear perspective, and cross-sectional views of another example mixer device in accordance with one or more examples of the present disclosure.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to mixer devices (e.g., a fluid mixer apparatus, a stationary mixing device for mixing fluids, an in-line fluid mixer, etc.). The mixer devices of the present disclosure are compatible with a variety of fluids, including fluids in various states, to induce mixing of two or more fluids. For instance, a fluid can include a gas, liquid, colloid, suspension, particulate fluid (e.g., with nanoparticles), ferro-fluid, etc. A fluid can also include various fluid properties (e.g., viscosity, temperature) and/or flow conditions, such as Newtonian, laminar, turbulent, or other flow types or conditions. A mixer device as disclosed herein can also be employed for many different flow rates, volume throughput requirements, etc. Similarly, a mixer device can be implemented in a wide variety of applications (e.g., inside a pipe, along a canal, between piping or hose connections, on a portable transportation vehicle or trailer, between reservoirs or tanks, etc.). A mixer device of the present disclosure can, thus, be implemented in a wide range of laboratory, industrial, and remote field uses. In specific implementations, a mixer device of the present disclosure can be adapted (e.g., geometries and structures tuned) for a particular fluid to be treated, including oil, gas, water, etc.

In at least some examples, a mixer device of the present disclosure can improve mixing and/or mixing efficiency relative to conventional mixing devices. For example, a mixer device of the present disclosure can reduce the time and/or fluid flow distance for homogeneous mixing of multiple fluids. As another example, a mixer device of the present disclosure can reduce or eliminate batch times, processing steps, intermediate storage reservoirs, reaction tanks, etc. that are typically implemented with conventional mixing devices and methods. Indeed, in some examples, a mixer device of the present disclosure can lend to improved efficiency of mixing, improved efficiency of space, pipe length, or equipment utilization, and/or improved cost efficiencies. In at least some instances, a mixer device of the present disclosure can be implemented with one or more fluids in-situ, during transport, at extraction, upon delivery, between storage tanks, etc. without conventional intermediate steps to induce mixing of fluids.

In these or other examples, a mixer device of the present disclosure includes a housing arranged with airfoils. The housing and the airfoils—although positionally fixed or stationary relative to each other and to a pipe (or other mounting application)—include a geometry and structural configuration that can efficiently and effectively induce mixing of fluids. The airfoils, for instance, can impart certain fluid conditions, flow patterns, relative differences in velocity, etc. Various airfoils can be utilized, including helical airfoils, arched (e.g., lenticular) airfoils, curved airfoils, linear airfoils, looped airfoils, or a combination thereof. Similarly, various housing shapes and sizes can be implemented (e.g., depending on the mounting location and/or space constraints). For example, the housing can be circular, square, triangular, or other polygonal shape. Housing shapes and sizes can also be implemented based on manufacturing considerations, including scalability, configurability, production processes, etc.

In more detail, a first fluid (which can include one or more fluids referred to in combination as a “first fluid”) can enter through a main opening of the mixer device. Additionally, the mixer device can receive a second fluid (which can include one or more other fluids) for injecting into the first fluid. For example, the mixer device can include a fluid inlet (e.g., an inoculant inlet) into the inside of the housing—the fluid inlet being different from and fluidly separate from the main opening of the mixer device. The fluid inlet can be in fluid communication with perforations defined in the airfoils to allow the second fluid from inside the housing to exit out of the perforations and into the first fluid as the first fluid flows past the airfoils.

In one or more examples, a mixer device of the present disclosure can include airfoil surface perturbations. The term “airfoil surface perturbation” can refer to any element or portion of the airfoil surface that can perturb fluid flow. In some examples, an airfoil surface perturbation can control fluid flow, induce mixing, and/or generate flow patterns (e.g., vortices, flow recursion, etc.) or flow conditions in fluids that flow past an airfoil. In particular examples, an airfoil surface perturbation can include wavelets (e.g., ridges, bumps, protrusions, etc.). Additionally or alternatively, an airfoil surface perturbation can include serrations (e.g., feathers, fingers, slit portions, etc.). Other airfoil surface perturbations are herein contemplated (e.g., cutaways, scallops, dimples, surface texturing, mesh overlays, flaps, ailerons, spoilers, rudders, kruegers, slats, stabilizers, winglets, trims, etc.). In these or other examples, airfoils surface perturbations can include positionally fixed or static elements. In certain implementations, however, airfoil surface perturbations can include control surfaces, actuatable portions, dynamic (movable) elements, responsive portions, etc.

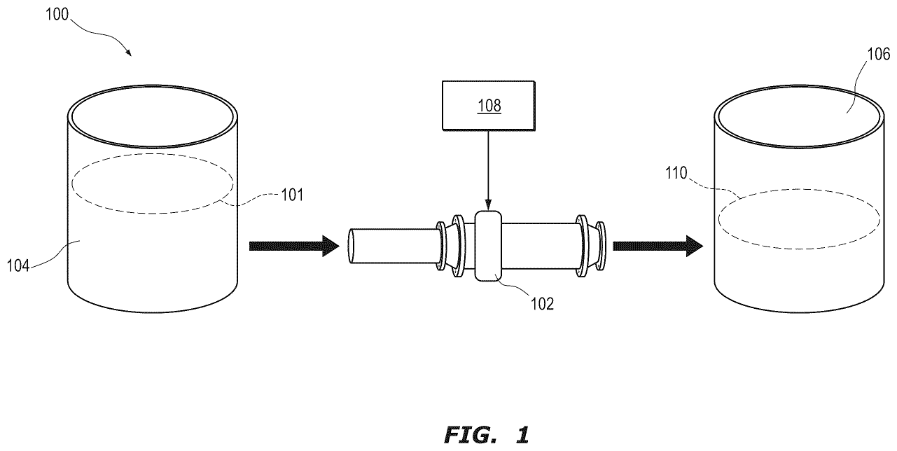

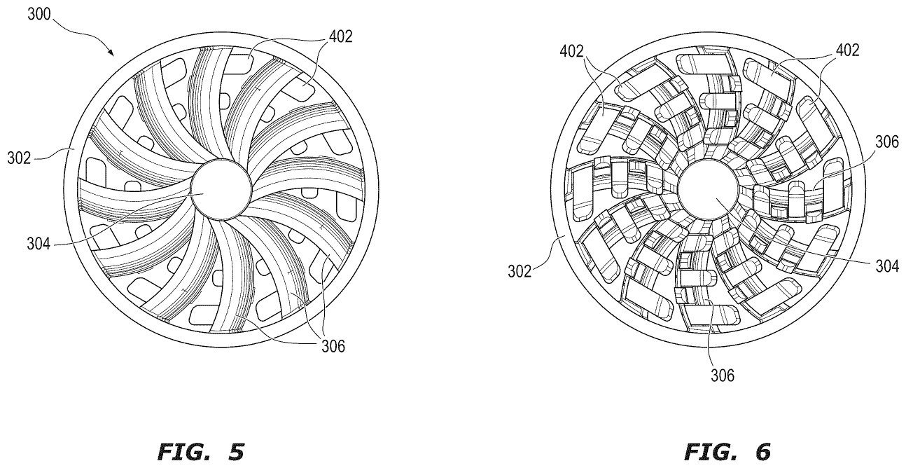

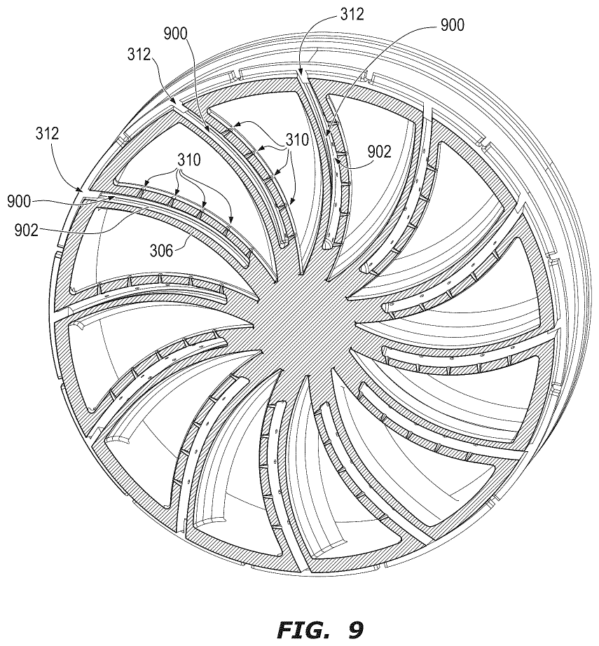

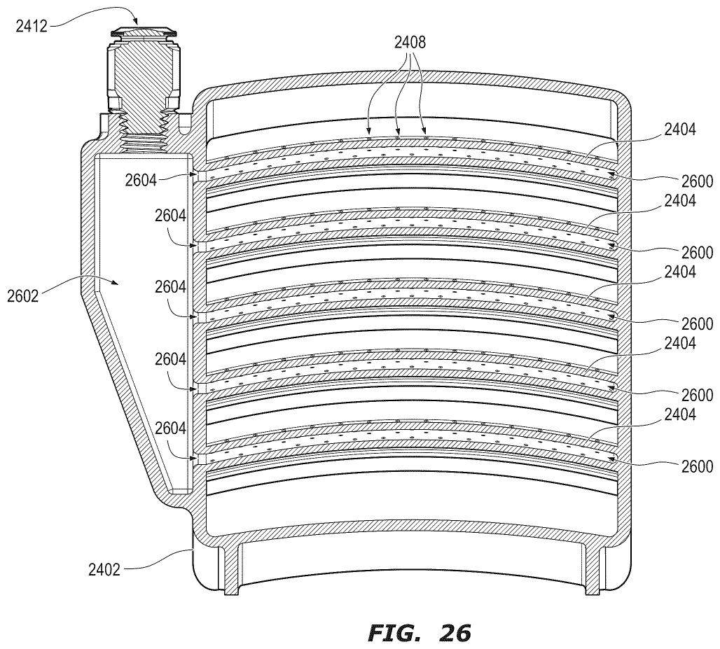

These and other examples are discussed below with reference to FIGS. 1-26. However, a person of ordinary skill in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates an example environment 100 for a mixer apparatus 102 (depicted schematically) in accordance with one or more examples of the present disclosure. In particular, FIG. 1 illustrates a first fluid 101 (e.g., a single fluid or multiple different fluids) associated with a source 104. In particular examples, the first fluid 101 can include a fluid in a first state or condition (e.g., a raw state, a preprocessed state, a pretreated state, an unmixed state, a transport state, a temporary state, etc.). The source 104 can therefore include a reservoir (e.g., a tank, storage container, or fluid body). Additionally or alternatively, the source 104 can include an originating location, a mining location, an extraction site, a drill well, a holding location, a treatment plant, a transportation vehicle, a testing facility, a laboratory, upstream piping, upstream rivers (or streams, creeks, canals), etc. The source 104 in particular examples is not limited to originating sources (i.e., the furthest upstream source). The source 104 can include any number of downstream sources from an originating source. For example, the source 104 can include a waste water treatment plant or reservoir (notwithstanding the waste water may originate from sewer lines or drains leading into the waste water treatment plant).

The mixer apparatus 102, as will be described in relation to subsequent figures, can mix in a second fluid 108 with the first fluid 101 to produce a mixed fluid 110. In FIG. 1, the mixer apparatus 102 is depicted schematically. In particular, the mixer apparatus 102 can mix in the second fluid 108 with the first fluid 101 as the first fluid 101 flows into (or through) the mixer apparatus 102. That is, the first fluid 101 can flow directionally from the source 104 toward the mixer apparatus 102. In some examples, the first fluid 101 is pumped, forced, or pressured flowed into the mixer apparatus 102. In other examples, the first fluid 101 is gravity fed, naturally flowed, or unaltered in its flow into the mixer apparatus 102.

The second fluid 108 can include one or more fluids that differ from the first fluid 101. In some examples, the second fluid 108 can include an inoculant. In certain implementations, the second fluid 108 can include one or more of acids, asphalten removers, cleaners and degreasers, CO₂ scavengers, corrosion inhibitors, defoamers, dispersants, emulsion breakers, foaming agents, H₂S scavengers, microbicides, oxygen scavengers, paraffin (wax) inhibitors, paraffin solvents, salt inhibitors, scale inhibitors, scale removers, sulfur removers, surfactants, water purifying agents, water clarifiers, etc.

In turn, the mixed fluid 110 (e.g., a combination, mixture, solution, suspension, cleaned fluid, filtered fluid, treated fluid, etc.) including the first fluid 101 and the second fluid 108 can move from the mixer apparatus 102 to a destination 106. The destination 106 can include any downstream location relative to the mixer apparatus 102. The destination 106 is, therefore, not limited to an end source (i.e., the furthest downstream location or use of the mixed fluid 110). In some examples, the destination 106 can include a fluid body, temporary container, storage tank, reservoir, tanker trailer (or semi-truck trailer), facility, consumer location, municipal piping, industrial end user location, factory, refinery, laboratory, etc.

In these or other examples, the source 104 and the destination 106 can be at different (e.g., remote, off-site) locations. In particular examples, however, the source 104 and the destination 106 can be at a same location (e.g., same facility, same laboratory, same transportation vehicle, etc.), albeit separated at least by the mixer apparatus 102. For example, the mixer apparatus 102 can be implemented in an on-site dosing system in which the first fluid 101 (e.g., distressed oil) is pumped through the mixer apparatus 102 (where mixing occurs with the second fluid 108) to generate the mixed fluid 110 (e.g., iron-treated oil), which is pushed downstream. As another example, the mixer apparatus 102 can be implemented in a mobile dosing system—such as a tanker trailer—in which the first fluid 101 (e.g., distressed oil) is pumped from the source 104 (e.g., a distressed oil tank on the tanker trailer) through the mixer apparatus 102 (where mixing occurs with the second fluid 108) to generate the mixed fluid 110 (e.g., iron chelate treated oil). The mixed fluid 110 can then be pushed downstream to the destination 106 (e.g., a treated oil tank on the same tanker trailer as the distressed oil tank).

Regardless of where the source 104 and the destination 106 are, the mixer apparatus 102 can enable in-situ mixing of fluids without requiring separate batch treatments, agitation baths, testing, etc. In omitting these conventional mixing steps, the mixer apparatus 102 can lend to improved system efficiencies by “stacking” (i.e., simultaneously performing) mixing of fluids and en route fluid delivery (e.g., transportation, piping, pumping, storing, etc.).

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 1.

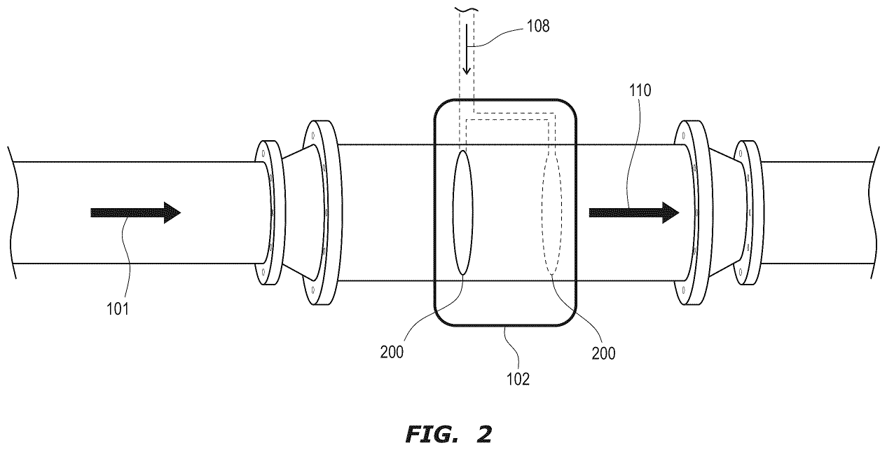

FIG. 2 illustrates a more detailed view of the environment 100, including the mixer apparatus 102, in accordance with one or more examples of the present disclosure. As shown in schematic form, the mixer apparatus 102 can include at least one mixer device 200. The mixer device 200 can receive the first fluid 101 and the second fluid 108 to generate the mixed fluid 110, as described above. For instance, the first fluid 101 can pass through the mixer device 200. As the first fluid 101 passes through the mixer device 200, the mixer device 200 can introduce the second fluid 108 into the first fluid 101 in such a way that causes the first fluid 101 and the second fluid 108 to thoroughly mix together, thereby creating the mixed fluid 110.

In FIG. 2, an optional second mixer device 200 is denoted via dashed lines. In such example embodiments including multiple mixer devices 200 (e.g., a first mixer device 200 and a second mixer device 200 placed in series to each other), each mixer device 200 can perform the same function as described above. The first fluid 101 can pass through the first mixer device 200. As the first fluid 101 passes through the first mixer device 200, the first mixer device 200 can introduce the second fluid 108 into the first fluid 101 in such a way that causes the first fluid 101 and the second fluid 108 to thoroughly mix together, thereby creating the mixed fluid 110. This portion of the mixed fluid 110 can then enter into the second mixer device 200. As the mixed fluid 110 enters into the second mixer device 200, more of the second fluid 108 can be introduced into the mixed fluid 110 and thoroughly mixed. Alternatively, as the mixed fluid 110 enters into the second mixer device 200, a third fluid (not shown) can be introduced into the mixed fluid 110 and thoroughly mixed to create a second mixed fluid. In this manner, mixing of multiple different inoculants can occur in stages using multiple, sequentially positioned mixer devices 200.

In these or other examples, multiple mixer devices 200 can be advantageous for improving mixing of fluids and/or for separately introducing (and mixing in) different inoculants. Multiple mixer devices 200 can be spaced apart or joined together, positionally offset (e.g., rotationally twisted relative to one or more other mixer devices 200), and/or arranged with differing structures (e.g., a first mixer device 200 with a first number of airfoils and a second mixer device with a differing number or differing geometry of airfoils). Multiple mixer devices 200 can also be advantageous for certain flow rates, volume throughput, and/or types of fluids. For example, multiple mixer devices 200 can be advantageous for higher flow rates and/or larger pipes (larger volume throughput) to help ensure thorough mixing of fluids. To illustrate, a 12-inch inner diameter pipe with water as the fluid may use two mixer devices 200, while a 2-inch inner diameter pipe with crude oil as the fluid may use a single mixer device 200. The number, arrangement, and structural configuration of the mixer devices 200 can thus vary widely based on the fluid and application of choice. In particular examples, the mixer apparatus 102 includes a single mixer device 200. In other examples, the mixer apparatus 102 includes multiple mixer devices 200 (e.g., 2 to 20 mixer devices, 4 to 18 mixer devices, 5 to 15 mixer devices, 7 to 12 mixer devices, or about 10 mixer devices).

Although FIG. 2 shows the mixer devices 200 positioned inside a pipe, the mixer devices 200 can be implemented in a wide variety of applications, as noted above. For example, the mixer devices 200 can be implemented in a canal, channel, or drain. The mixer devices 200 can also be implemented at (or along) fluid connections or fluid intersections. The mixer devices 200 can be positioned at open ends (e.g., connected to open ends of pipes, hoses, conduits, etc.). The mixer devices 200 do not require a closed-environment or an open environment and can thus be adapted for a wide variety of positional applications. Indeed, the mixer devices 200 can be modular in nature (e.g., stacked, positioned in series with each other, or adapted for versatile and custom applications) allowing the first fluid 101 to flow freely through and over the mixer device structure and evenly mix with or contact the second fluid 108—regardless of application.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 2.

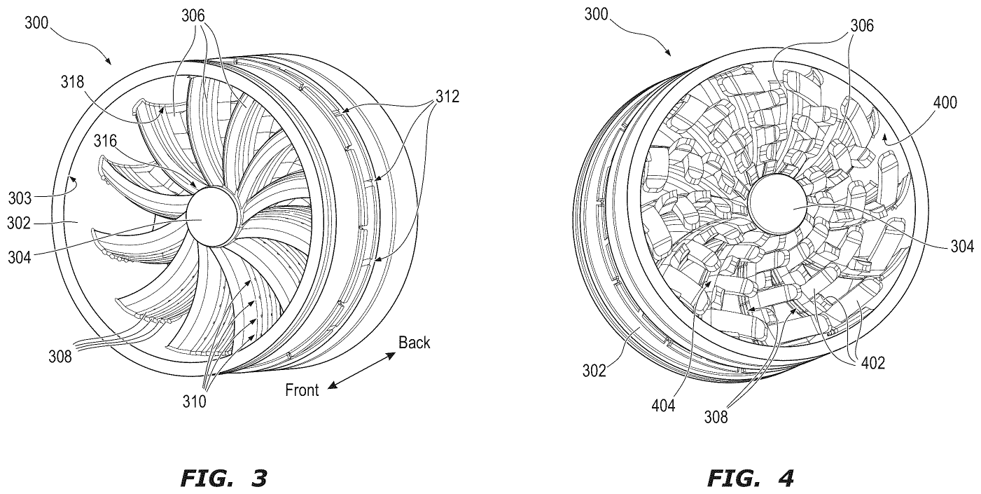

FIGS. 3-6 illustrate a mixer device 300 in accordance with one or more examples of the present disclosure. The mixer device 300 can be the same as or similar to the mixer devices 200 described above.

As shown, the mixer device 300 can include a housing 302. The housing 302 can include a framework, shell, body structure, or enclosure of the mixer device 300. The housing 302 can include a variety of shapes and sizes (e.g., depending on the application of the mixer device 300). In particular examples, the housing 302 includes an annular ring, cylinder, or torus. In these or other examples, the housing 302 can define a main opening 303 through which fluid (e.g., the first fluid 101 discussed above) can enter and an exit opening 400 through which a combination of fluids (e.g., the mixed fluid 110 discussed above) can exit the mixer device 300. In some examples, the main opening 303 is sized and shaped the same as or similar to the exit opening 400.

The mixer device 300 can additionally include airfoils 306. The term “airfoil” can include a shaped member to impart fluid properties and/or leverage fluid mechanics in a fluid system. In some examples, an airfoil includes a shaped member that induces a faster fluid velocity over a first surface and a slower fluid velocity over a second surface. An airfoil can cause a fluid to move in certain patterns or generate fluid interactions. An airfoil, for example, can separate oncoming fluid into discrete mixing portions that can receive or mix with an inoculant or second fluid (as will be described below). In particular, an airfoil can include a leading edge (e.g., a leading edge 314) that splits oncoming fluid into a first fluid portion that flows faster across the top surface of the airfoil and a second fluid portion that flows slower across the bottom surface. The leading edge of an airfoil and a trailing edge of an airfoil are contiguous with the major airfoil surfaces (e.g., the top and bottom surfaces of the airfoil).

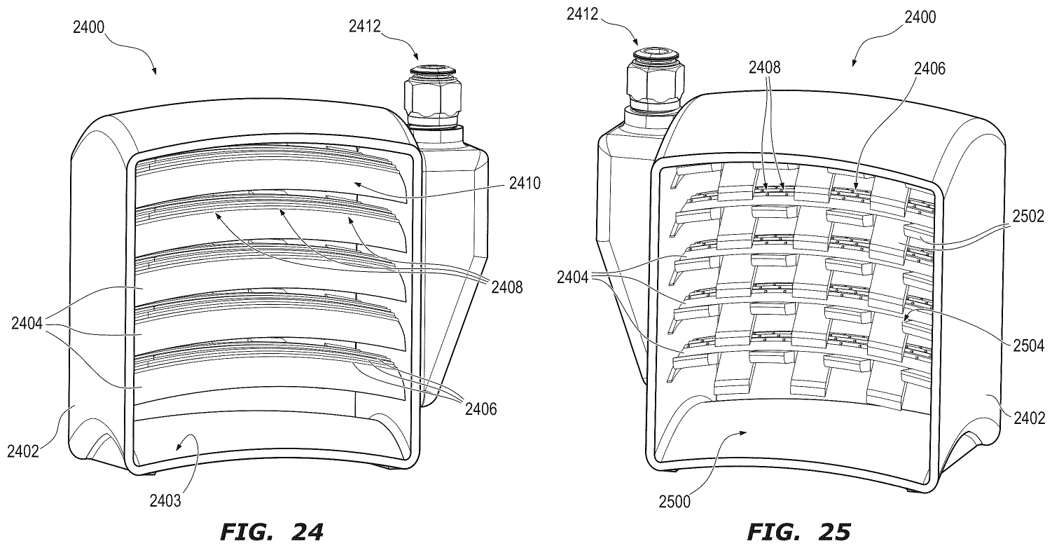

The airfoils 306 can have a variety of sizes and shapes. For example, the airfoils 306 can be helical (as shown), arched (e.g., lenticular, as shown in FIGS. 24-26), curved, linear, looped, or a combination thereof. Airfoil sizes (e.g., airfoil thickness between top and bottom surfaces, airfoil width between a leading edge 314 and trailing edge 404, or airfoil length between an inboard portion 316 and an outboard portion 318) can be tuned based on fluid properties, flow rate, volume throughput, desired mixing level (i.e., degree of mixing completeness). Similarly, airfoil pitch (e.g., angle of attack of the leading edge 314) and airfoil curvature or geometry can affect desired mixing levels subject to fluid properties, flow rate, volume throughput, etc. A quantity of the airfoils 306 (and/or spacing between each of the airfoils 306) can also be tuned or optimized for desired mixing levels, fluid properties, flow rate, volume throughput, etc. Indeed, although shown as including 12 airfoils, the airfoils 306 can include more or fewer airfoils (e.g., between 2 airfoils and 30 airfoils, between 4 airfoils and 25 airfoils, between 8 airfoils and 20 airfoils, or about 15 airfoils).

The airfoils 306 can fixedly attach to the housing 302 and a central hub 304 (e.g., a core portion, center mount, middle anchor, main shaft, nose, etc.). That is, the airfoils 306 in some examples are, unlike a turbine or propeller, immovable relative to the housing 302 (and the central hub 304). The airfoils 306, in some examples, are thus positionally fixed at both ends. Specifically, the inboard portion 316 (e.g., the innermost end portions of the airfoils 306) can be fixed to the central hub 304, and the outboard portion 318 (e.g., the outermost end portions of the airfoils 306) can be fixed to the housing 302.

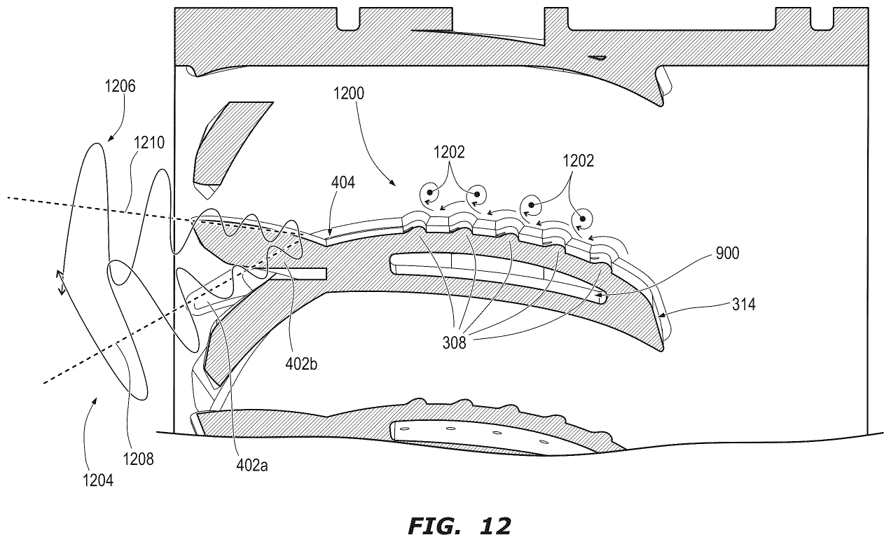

In some examples, the airfoils 306 can include airfoil surface perturbations 308. The airfoil surface perturbations 308 can, in particular examples, include wavelets (e.g., ridges, bumps, protrusions, etc.). The airfoil surface perturbations 308 can be rounded or curved in some examples. Additionally or alternatively, the airfoil surface perturbations 308 can include corners, vertices, or edges. In some examples, the airfoil surface perturbations 308 can generate certain flow patterns and/or flow conditions for a fluid passing over and/or around the airfoil surface perturbations 308. In specific examples, the airfoil surface perturbations 308 can induce flow recursion (as will be discussed below in relation to FIG. 12). In these or other examples, the airfoil surface perturbations 308 can help mix in a second fluid (or inoculant) with a first fluid proceeding through the main opening 303.

The airfoil surface perturbations 308 can be arranged in a variety of configurations according to fluid properties, flow rate, volume throughput, desired mixing levels, etc. In some examples, a structural configuration (e.g., a geometry or arrangement) of the airfoil surface perturbations 308 (and/or the airfoil surface perturbations 402 described below) can be tuned to a specific fluid. For instance, the geometry of the airfoil surface perturbations 308 can be tuned to the flow characteristics of the oncoming fluid to enter through the main opening 303 and/or the inoculant to be introduced via the airfoils 306.

In some examples, the airfoil surface perturbations 308 are positionally arranged perpendicular to the fluid flow path coming into the main opening 303. That is, the airfoil surface perturbations 308 can be positioned along a top (and/or bottom) surface of the airfoils 306 in a lengthwise fashion, extending at least partially between the inboard portion 316 and the outboard portion 318. In particular examples, the airfoil surface perturbations 308 extend an entire length of the airfoils 306 between the inboard portion 316 and the outboard portion 318.

In one or more examples, the airfoil surface perturbations 308 can include a series of wavelets (e.g., multiple rows of wavelets) on a given airfoil surface. For example, and as shown, the airfoil surface perturbations 308 can include a series of wavelet rows aligned one after (or rearward of) the other. In alternative examples, the airfoil surface perturbations 308 can include offset or staggered rows such that there is only partial overlap between subsequent wavelet rows (e.g., a first wavelet row extends from the inboard portion 316 toward a portion just past the middle of the airfoil, and a second wavelet row extends from the outboard portion 318 toward a portion just past the middle of the airfoil, thereby creating wavelet “overlap” in a middle section of the airfoil).

The individual rows of the airfoil surface perturbations 308 can also include a variety of configurations. In some examples, the individual rows of the airfoil surface perturbations 308 follow a single, straight path along the airfoil surface. In other examples, the airfoil surface perturbations 308 include other configurations (e.g., zig-zag configurations, pointed V-shape configurations, etc.). A given wavelet row of the airfoil surface perturbations 308 can also be discontinuous (e.g., a line of discrete protuberances, risers, bulges, projections, etc. that are interspaced by unperturbed airfoil surface). As a whole, each of the airfoil surface perturbations 308 can be structurally configured or arranged in the same way. Alternatively, the airfoil surface perturbations 308 can differ from row to row of wavelets, alternate between row configurations, etc. (e.g., a first zig-zag row, a second straight row, a third zig-zag row, a fourth straight row, and so forth).

In some examples, the airfoils 306 can include perforations 310. The perforations 310 can include openings, slits, through-holes, etc. that extend from the outer surface of the airfoils 306 to an interior portion defining an inner channel or cavity (shown in FIG. 9). In these or other examples, the perforations 310 fluidly connect an interior portion of the airfoils 306 and an exterior portion of the airfoils 306. In addition, the perforations 310 can be in fluid communication with fluid inlets 312. In this manner, a fluid (e.g., an inoculant) can pass into the fluid inlets 312, through an interior cavity of the airfoils 306, and out through the perforations 310 to mix with another fluid passing into the main opening 303 and across the airfoils 306.

The perforations 310 can be arranged in a variety of different ways depending on fluid properties, flow rate, volume throughput (e.g., of inoculant), desired mixing levels, etc. The perforations 310 can be defined by any major surface (e.g., the top surface and/or the bottom surface) of the airfoils 306. In specific examples, the perforations 310 are defined by the same airfoil surface as the airfoil surface perturbations 308. For example, the perforations 310 can be positioned adjacent to (e.g., on the airfoil surface perturbations 308, immediately in front of the airfoil surface perturbations 308, immediately behind or rearward of the airfoil surface perturbations 308, etc.). In specific implementations, the perforations 310 are positioned along a length of the airfoil surface perturbations 308. In other examples, the perforations 310 are positioned spaced apart from the airfoil surface perturbations 308 (e.g., rearward of and approximately halfway between wavelet rows). A perforation density, size (e.g., diameter), and/or spacing of the perforations 310 can also affect desired mixing levels and/or inoculant volume throughput. In some examples, the perforation density, size, and/or spacing of the perforations 310 can also affect fluid pressurization of the inoculant. Thus, in some embodiments, fluid pressurization to force fluid out through the perforations 310 can be tuned based on the density, size, and/or spacing of the perforations 310 (among other factors, such as fluid viscosity, resonance frequency of one or more fluids, interior airfoil cavity volume, fluid inlet size, etc.).

In at least some examples, the fluid housed within the interior portion of the housing 302 and the airfoils 306 has a greater fluid pressure than the fluid pressure in the ambient environment of the mixer device 300 at the perforations 310. The pressure differential can, as noted above, force the inoculant inside the airfoils 306 to proceed out through the perforations 310 rather than allowing ambient fluid passing over the airfoils 306 to enter into the perforations 310. In some examples, the pressure differential can range from about 2 pounds/square inch (PSI) to about 50 PSI, about 5 PSI to about 40 PSI, about 8 PSI to about 16 PSI, about 10 PSI to about 25 PSI, or about 30 PSI to about 40 PSI.

As shown in FIGS. 4-6, the mixer device 300 can, in some examples, include airfoil surface perturbations 402 extending from the trailing edge 404. The airfoil surface perturbations 402 can include serrations (e.g., feathers, fingers, slit portions, etc.). The airfoil surface perturbations 402 (as depicted) can be positioned rearward (i.e., behind) the airfoil surface perturbations 308 and the perforations 310. In some examples, and as shown, the airfoil surface perturbations 402 can be pitched out of plane relative to the trailing edge 404 (where “out of plane” refers to a relative non-planar positioning). In some examples, the airfoil surface perturbations 402 can alternate in pitch direction along the trailing edge 404 (e.g., a first serration angled up from the trailing edge 404, a second serration angled down from the trailing edge 404, a third serration angled up, a fourth serration angled down, and so forth). In these or other examples, alternating pitch angles of the airfoil surface perturbations 402 can help induce interacting vortices in the fluid flow to aid mixing (as will be described more below in relation to FIG. 12).

In at least some examples, the pitch angle of the airfoil surface perturbations 402 relative to the trailing edge 404 can vary between the inboard portion 316 and the outboard portion 318. For instance, the pitch angle of the airfoil surface perturbations 402 can progressively increase from the inboard portion 316 to the outboard portion 318 (e.g., from about 2 degrees to about 90 degrees, about 4 degrees to about 75 degrees, about 5 degrees to about 50 degrees, about 8 degrees to about 30 degrees, about 10 degrees to about 25 degrees, or about 5 degrees to about 30 degrees). In other instances, the pitch angle of the airfoil surface perturbations 402 can progressively decrease from the inboard portion 316 to the outboard portion 318, as spatial constraints may permit.

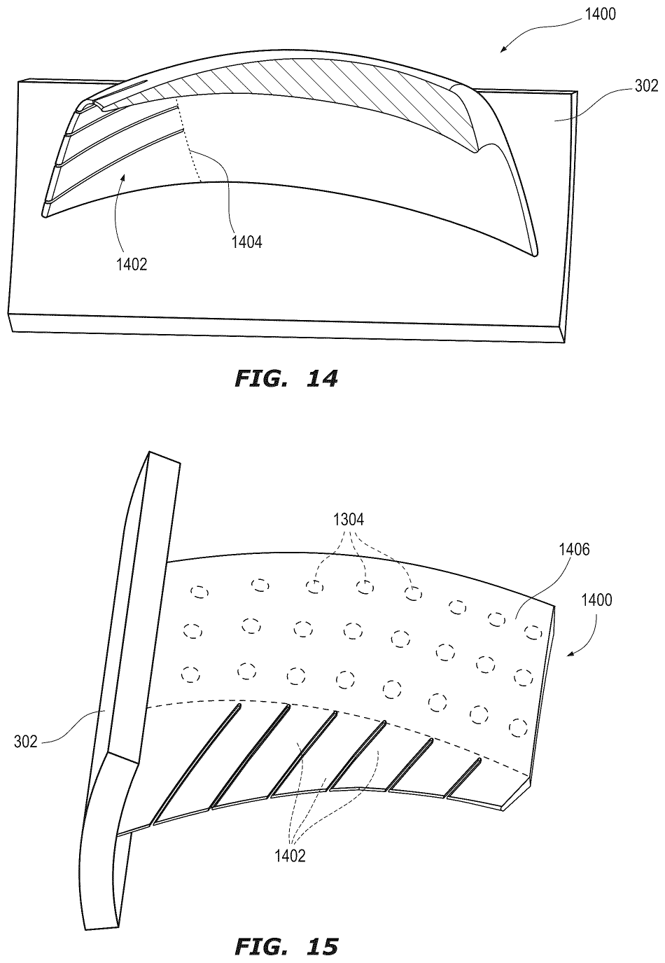

In these or other examples, progressively changing pitch angles of the airfoil surface perturbations 402 can also aid mixing by inducing interacting vortices in the fluid flow and/or by varying exiting fluid velocities and flow patterns in fluids that leave through the exit opening 400. In some examples, progressively changing pitch angles of the airfoil surface perturbations 402 can also ensure mixing of fluids with fluid portions that travel along the underside of an airfoil (e.g., to mix up fluids forming a boundary layer along the underside of the airfoils 306 that may not have the airfoil surface perturbations 308 to induce mixture). In yet another example, progressively changing pitch angles of the airfoil surface perturbations 402 can mix up fluids flowing in regions interspaced between the airfoils 306 (and not necessarily across or along an airfoil surface). Alternatively, in some examples (e.g., as shown in FIGS. 14-15), the airfoil surface perturbations 402 are not pitched out of plane relative to the trailing edge 404.

Further, in some examples, a serration length (e.g., the finger length or distance from the serration tip to the trailing edge 404) of the airfoil surface perturbations 402 can vary between the inboard portion 316 and the outboard portion 318. For instance, the serration length of the airfoil surface perturbations 402 can progressively increase from the inboard portion 316 to the outboard portion 318 (e.g., from about 2 mm to about 100 mm, about 4 mm to about 75 mm, about 5 mm to about 50 mm, about 8 mm to about 30 mm, about 10 mm to about 35 mm, or about 15 mm to about 25 mm). In other instances, the serration length of the airfoil surface perturbations 402 can progressively decrease from the inboard portion 316 to the outboard portion 318, as spatial constraints may permit. In some examples, the serrations can be longer (or larger) toward the outboard portion 318 because more volume of fluid can tend to flow through the larger gaps between the airfoils 306 (e.g., where the larger gaps are closer to the outboard portion 318 than the inboard portion 316) and thus longer serrations near the outboard portion 318 can be proportionally sized for greater mixing of a greater localized volume throughput than may occur at the inboard portion 316. Numerical methods or simulation may be used to tune these features for mixing of certain fluids (e.g., according to fluid properties, such as the viscosity or natural frequency of a fluid).

In addition to pitch angle and serration length, the airfoil surface perturbations 402 can include a wide variety of different configurations also dependent on fluid properties, flow rate, volume throughput, desired mixing levels, etc. For example, the airfoil surface perturbations 402 can include various different spacing or feather density. As another example, the airfoil surface perturbations 402 can be positioned along an entirety of the trailing edge 404, while in other examples only along a portion of the trailing edge 404. The airfoil surface perturbations 402 can also include a variety of different geometries. In some examples, and as shown, the airfoil surface perturbations 402 are curved. In other examples, the airfoil surface perturbations 402 can be straight, have discrete linear segments (e.g., a first segment at a first angle relative to the trailing edge 404 and a second segment at a second angle relative to the trailing edge 404), include twisted portions (e.g., helical portions), include multi-directional portions (e.g., a first portion parallel to fluid flow and a second portion perpendicular to fluid flow), etc. Still, in other examples, the airfoil surface perturbations 402 can include biomimicry designs (e.g., as adapted from certain feathers of birds of prey). In such designs, fluid flow (e.g., air flow) can be modified to increase or decrease fluid flow efficiency by tuning structural aspects, such as geometry or angle of attack, to achieve a specific flow result.

In one or more examples, the airfoil surface perturbations 402 include static or fixed members relative to the airfoils 306. That is, the airfoil surface perturbations 402 can be positionally immovable or rigid. In some examples, the airfoil surface perturbations 402 can be flexible, bendable, or pliant (e.g., to dynamically maintain homogeneity of mixing in response to changing fluid conditions). In particular examples, the airfoil surface perturbations 402 can be moldable or conformable to user adjustments (e.g., for in-field modifications). In other examples, the airfoil surface perturbations 402 can be manipulated or actuated. For example, the airfoil surface perturbations 402 can be actively actuated via wire tensioning, motor control, etc. In some examples, the airfoil surface perturbations 402 can be actuated in response to thermal activation (e.g., via thermally activated serration materials, such as Nitinol).

Any of the features, components, and/or parts, including the arrangements and configurations thereof shown in FIGS. 3-6 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 3-6.

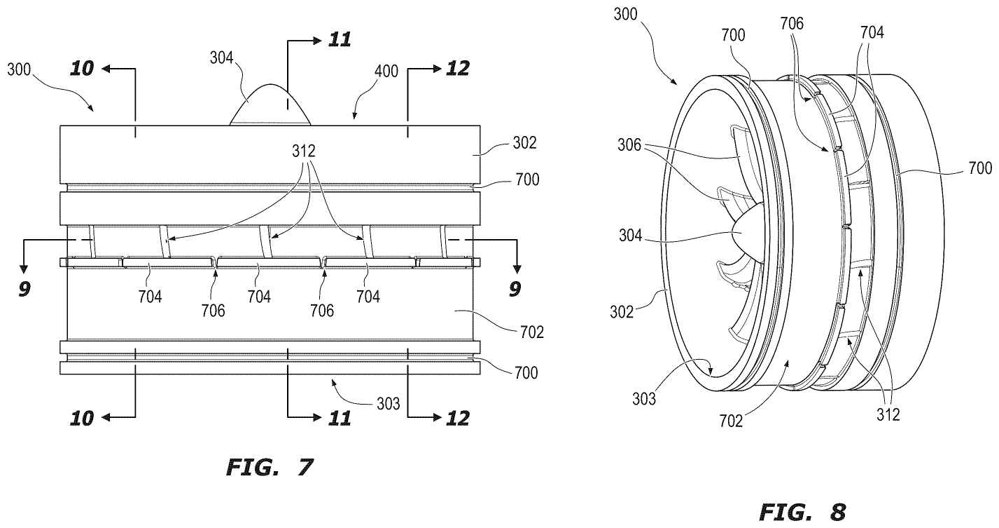

FIGS. 7-11 illustrate additional views of the mixer device 300 in accordance with one or more examples of the present disclosure. As shown, the mixer device 300 can include seal channels 700. The seal channels 700 can include grooves, indentations, notches, or seating portions that extend about the housing 302. In some examples, the seal channels 700 are sized and shaped to receive O-rings or other sealing components (not shown) that can engage the inner wall of a pipe, conduit, channel, etc. in which the mixer device 300 is placed. In this manner, the exterior portion of the housing 302 between the seal channels 700 can be fluidly sealed from the ambient environment. In so doing, fluid is disallowed from bypassing the main opening 303. That is, a seal within the seal channels 700 can prevent fluid from going around the mixer device 300 rather than through the mixer device 300 via the main opening 303 and out of the exit opening 400.

Additionally or alternatively, a seal disposed within the seal channels 700 (and seated against a pipe sidewall, for instance) can enable a second fluid (or inoculant) to be pressurized and forced into the fluid inlets 312—thereby enabling the pressure differential discussed above. For example, a second fluid can be injected into an injection cavity 702 positioned between the seal channels 700. A seal within the seal channels 700 having a sealing engagement with a pipe or other ambient environment component can prevent escape of the second fluid beyond the seal channels 700. Thus, with fluid pressure, the second fluid can be forced into the injection cavity 702 and subsequently into the fluid inlets 312 via slots 706 defined in ribs 704.

In particular examples, the ribs 704 (e.g., risers, protrusions, projections, etc.) can separate the injection cavity 702 from the fluid inlets 312 to at least partially direct (and more evenly control) fluid from the injection cavity 702 into the fluid inlets 312. In some examples, the ribs 704 are circumferentially disposed about the housing 302. In some examples, the ribs 704 can also be sized and shaped to engage (e.g., contact or abut against) a pipe sidewall. In other examples, the ribs 704 can be sized and shaped for positioning adjacent to or in close proximity to a pipe sidewall.

As mentioned, the ribs 704 can control (or more evenly spread) fluid ingress from the injection cavity 702 into the fluid inlets 312. Thus, in some examples, the slots 706 of the ribs 704 can be positioned offset relative to the fluid inlets 312 (e.g., at approximately halfway between the fluid inlets 312). In one or more examples, a positional offset of the slots 706 relative to the fluid inlets 312 can improve fluid spread or consistency of fluid volume injected into each of the fluid inlets 312 (rather than some of the fluid inlets 312 receiving more or less inoculant than other fluid inlets 312).

As shown in FIG. 9, injected fluid (e.g., inoculant) can enter the fluid inlets 312 and into a cavity 900 defined by an interior portion 902 of each of the airfoils 306. The cavity 900 can include a hollowed-out section, empty core, or internal volume in each of the airfoils 306, where the interior portion 902 (e.g., the interior airfoil surfaces) define the metes and bounds of the cavity 900. In some examples, the cavity 900 extends substantially between the leading edge 314 and the trailing edge 404. In other examples, the cavity 900 includes a central artery or channel, from which smaller capillaries can feed into the perforations 310 (as discussed below in relation to FIG. 19).

Once the fluid injected into the fluid inlets 312 enters the cavity 900, the fluid can spread throughout the cavity 900. In particular examples, the cavity 900 is pressurized at a positive pressure that is greater than a fluid pressure at the top surface of the airfoil (e.g., the ambient fluid pressure of the oncoming first fluid through the airfoil). The fluid can, with a sufficient positive pressure differential exceeding the ambient fluid pressure, then exit the airfoils 306 through the perforations 310. In particular examples, a positive pressure differential can also help to accurately meter (e.g., control, throttle, or balance) a throughput volume of the inoculant out through the perforations 310 while also helping to prevent backflow of the first fluid into the perforations 308.

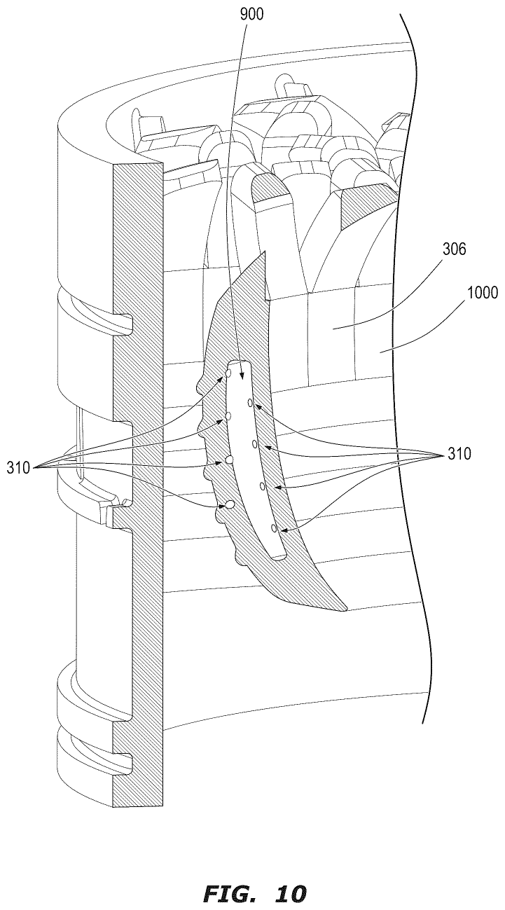

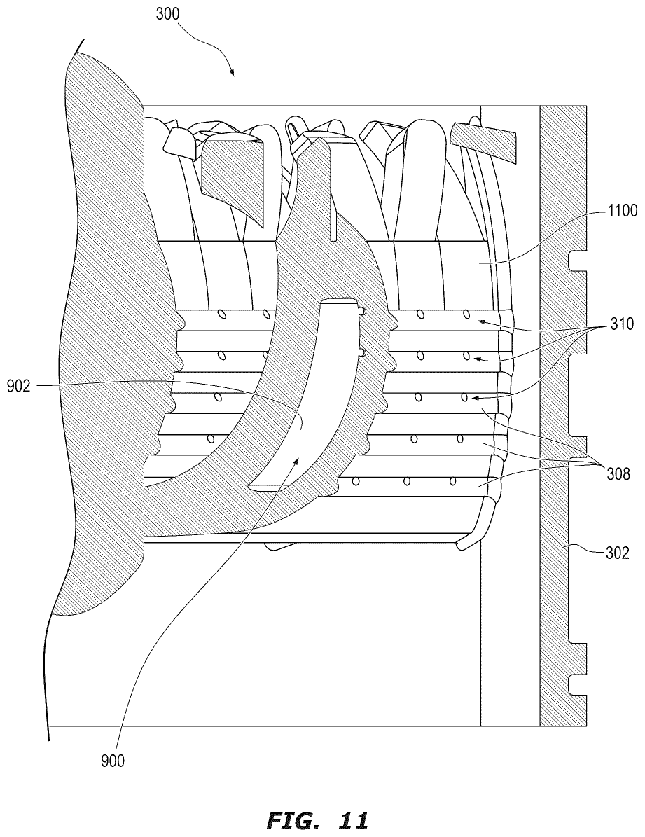

Indeed, as shown in FIGS. 10-11 respectively depicting bottom perspective and top perspective cross-sectional views of one of the airfoils 306, fluid can leave the cavity 900 and exit the airfoil 306 through the perforations 310 defined in a top surface 1100 opposite a bottom surface 1000 of the airfoil 306. As the fluid exits the perforations 310, mixing can occur along the airfoil surface perturbations 308 and the airfoil surface perturbations 402 (as discussed above, and as will be described in greater detail below in relation to FIG. 12).

Any of the features, components, and/or parts, including the arrangements and configurations thereof shown in FIGS. 7-11 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 7-11.

FIG. 12 illustrates a cross-sectional view of an airfoil and mixing events associated therewith in accordance with one or more embodiments of the present disclosure. As used herein, the term “mixing event” can refer to any mixing of two or more fluids. In particular examples, which will now be discussed, are mixing events that can occur in relation to one or more airfoil surface perturbations (specifically the airfoil surface perturbations 308 and the airfoil surface perturbations 402).

A first mixing event can include fluid recursion 1200 that can occur as oncoming fluid hits the leading edge 314 and begins to pass over the airfoil surface perturbations 308 (and as inoculant proceeds from the cavity 900 out of the perforations 310). In particular, fluid recursion 1200 can include fluid eddies that rise upward and roll backward onto themselves about rotational axes 1202. For instance, the shape, curvature or flow impediment provided by the airfoil surface perturbations 308 can cause the fluid eddies to form and proceed over the airfoils 306 (e.g., between the leading edge 314 the trailing edge 404). Additionally or alternatively, the positioning and orientation of the perforations 310 can aid formation of the fluid eddies as inoculant proceeds out of the perforations 310 at a non-parallel angle relative to the fluid flow over the airfoils 306. The fluid eddies can, in some examples, compound or interact with each other. In particular examples, the fluid eddies can mix together the inoculant and the oncoming fluid. In these or other examples, the first mixing event as just described occurs (or at least begins) as fluid crosses over the airfoil 306 before reaching the trailing edge 404.

A second mixing event can occur after the trailing edge 404. In particular, the second mixing event can include various vortices that form as the fluid recursion 1200 leads into the trailing edge 404 and across the airfoil surface perturbations 402. In some examples, a second mixing event can include vortices (e.g., swirls) that occur after or behind the trailing edge 404. For instance, a first airfoil surface perturbation 402a can induce a first vortex 1204 having a rotational axis 1208, and a second airfoil surface perturbation 402b can induce a second vortex 1206 having a rotational axis 1210. In these or other examples, the rotational axes 1208, 1210 for the second mixing event can be perpendicular to the rotational axes 1202 of the first mixing event. Additionally, in some examples, the vortices 1204, 1206 can be interacting vortices. For example, the vortices 1204, 1206 can include tight, small flow fields adjacent to the tips of the airfoil surface perturbations 404a, 404b that gradually become larger and larger until the vortices 1204, 1206 interact (e.g., cross into or intersect one another) at farther distances way from the tip-ends of the airfoil surface perturbations 404a, 404b.

In these or other examples, the first mixing event and the second mixing event can be tuned and optimized according to fluid properties, flow rate, volume throughput, desired mixing levels, etc. To do so, the airfoil surface perturbations 308 and the trailing edge 404 can be structurally predetermined, modified, custom tailored, tested, simulated, and/or certified to induce a desired mixing level based on certain flow conditions.

Any of the features, components, and/or parts, including the arrangements and configurations thereof shown in FIG. 12 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 12.

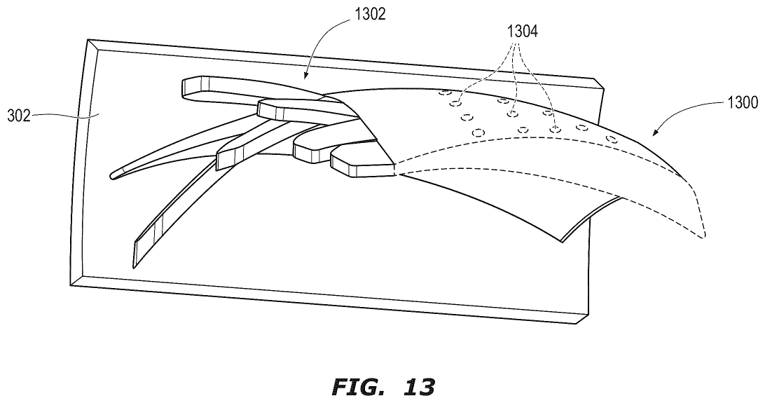

The foregoing figures (specifically FIGS. 3-12) illustrate one example of a mixer device. The present disclosure is not so limited, however. Indeed, the present disclosure contemplates many variations and modifications to the mixer device 300 that fall within the scope of this application. For example, any of the foregoing features (including the structural configurations, geometries, and arrangements) of a disclosed mixer device described above can modified, tuned or optimized for a specific use environment and/or a particular fluid application. As used herein, the term “optimize” should be interpreted to mean “improved,” “enhanced” or “local optima,” and not necessarily as “absolute optima,” “true optimization” or the “best,” although an “absolute optima” or “best” may still be covered by the present disclosure. For example, an optimization process (e.g., a simulation, fluid flow analysis, etc.) may improve upon a previous solution, may find the best solution, or may verify that an existing solution is a “local optima” or an “absolute optima” and thus should not be modified or changed. The following description with respect to FIGS. 13-26 briefly describes a few such example mixer devices.

In some examples, an airfoil can include serrations but omit at least one of perforations or wavelets. In accordance with one or more such examples, FIG. 13 illustrates an example airfoil 1300 of another example mixer device. For purposes of illustration, only a portion of the mixer device housing is shown that connects to an outboard portion of a single airfoil (i.e., the airfoil 1300). As shown, a mixer device can include one or more airfoils structured like the airfoil 1300, which includes serrations 1302. The serrations 1302 can be the same as or similar to the airfoil surface perturbations 402 described above. Optionally, the airfoil 1300 can include perforations 1304, which can be the same as or similar to the perforations 310 described above for introducing and mixing in an inoculant. Unlike the airfoils 306 described above, however, the airfoil 1300 may not include wavelets disposed on a major surface of the airfoil 1300. In these or other examples, a mixing event can occur at the serrations 1302 in a manner similar to the second mixing event with interacting vortices described above in relation to FIG. 12.

Any of the features, components, and/or parts, including the arrangements and configurations thereof shown in FIG. 13 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 13.

As described in conjunction with FIG. 13, some example mixer devices include airfoils that do not include wavelets. Additionally, in some examples, a mixer device can include airfoils in which the serrations are not pitched out of plane relative to the trailing edge and, instead, generally follow the overall curvature of the major surfaces of the airfoil. In accordance with one or more such examples, FIGS. 14-15 respectively illustrate side and top views of an example airfoil 1400 of yet another mixer device. For purposes of illustration, only a portion of the mixer device housing is shown that connects to an outboard portion of a single airfoil (i.e., the airfoil 1400).

As shown, the airfoil 1400 can include serrations 1402 (and optionally, the perforations 1304). Similar to the airfoil surface perturbations 402 and the serrations 1302, the serrations 1402 can gradually increase in length from the inboard portion to the outboard portion. The serrations 1402 can also include similar discrete fingers or members, which can be spaced apart from adjacent serration members. Unlike the airfoil surface perturbations 402 and the serrations 1302 depicted in the foregoing figures, however, the serrations 1402 are in-plane with a trailing edge 1404 and a top surface 1406. The serrations 1402 are not alternately angled relative to each other. In particular, the serrations 1402 are not angled differently relative to the trailing edge 1404 and the top surface 1406. The serrations 1402 instead continue to follow the curvature of the top surface 1406 after the trailing edge 1404. In these or other examples, a modified mixing event can occur at the serrations 1402. For example, the slots or gaps (which can be tuned for optimized mixing performance) between individual serration members of the serrations 1402 can induce desired mixing, in addition to the mixing that occurs as fluids cross over and between airfoils.

Any of the features, components, and/or parts, including the arrangements and configurations thereof shown in FIGS. 14-15 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 14-15.

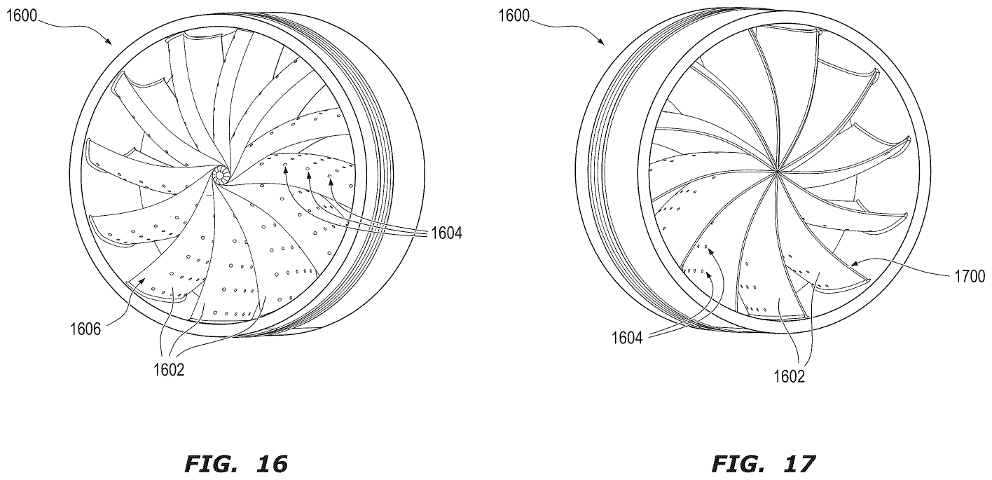

In some examples, a mixer device can include airfoils without any airfoil surface perturbations (e.g., no wavelets, no serrations, etc.). In accordance with one or more such examples, FIGS. 16-20 respectively illustrate front perspective, rear perspective, side perspective, and various cross-sectional views of a mixer device 1600. As shown, the mixer device 1600 can include airfoils 1602 with perforations 1604, similar to the airfoils 306 and corresponding perforations 310. Between a leading edge 1606 and a trailing edge 1700, however, the major surfaces of the airfoils 1602 are devoid of any airfoil surface perturbation.

In these or other examples, fluid mixing can occur due to fluid engagement with the airfoils 1602. For example, oncoming fluid can contact and split at the leading edge 1606 of the airfoils 1602 and cross over the airfoils 1602 to intersect inoculant dispersed from the perforations 1604. The differing fluid velocities between the underside and topside of the airfoil surfaces can also induce desired mixing of fluids.

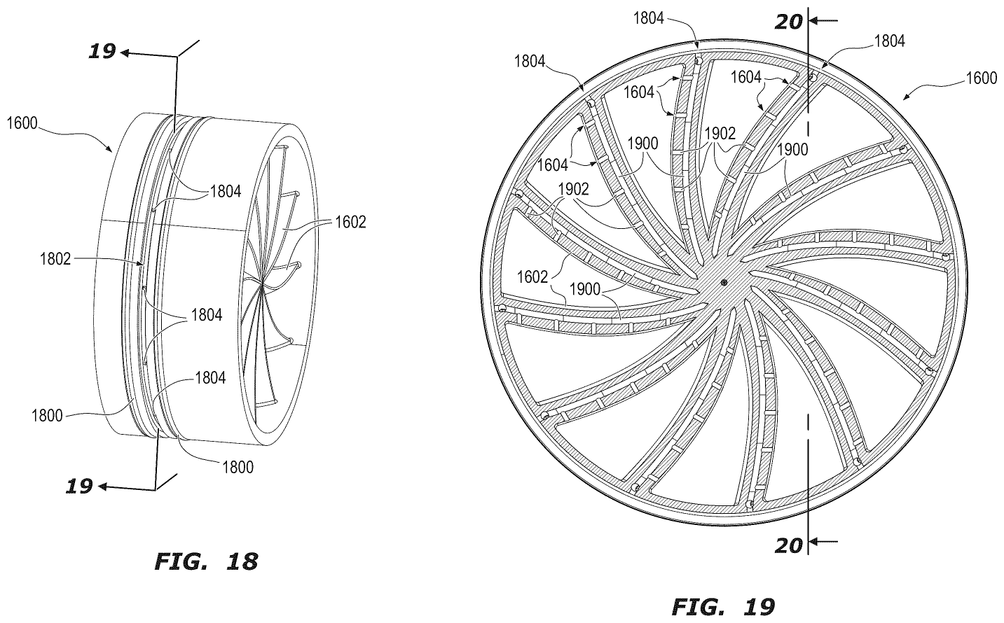

As shown in FIG. 18, the mixer device 1600 can include seal channels 1800, which can be the same as or similar to the seal channels 700 discussed above. A second fluid (e.g., an inoculant) can be pressurized and pumped into an injection cavity 1802, which is fluidly sealed off from the ambient environment via seal components or gaskets positioned within the seal channels 1800 to control volume output of the inoculant and help mitigate backflow of the first fluid into the airfoil perforations (as discussed above). In the mixer device 1600, the injection cavity 1802 positionally coincides with fluid inlets 1804 defined in the housing surface.

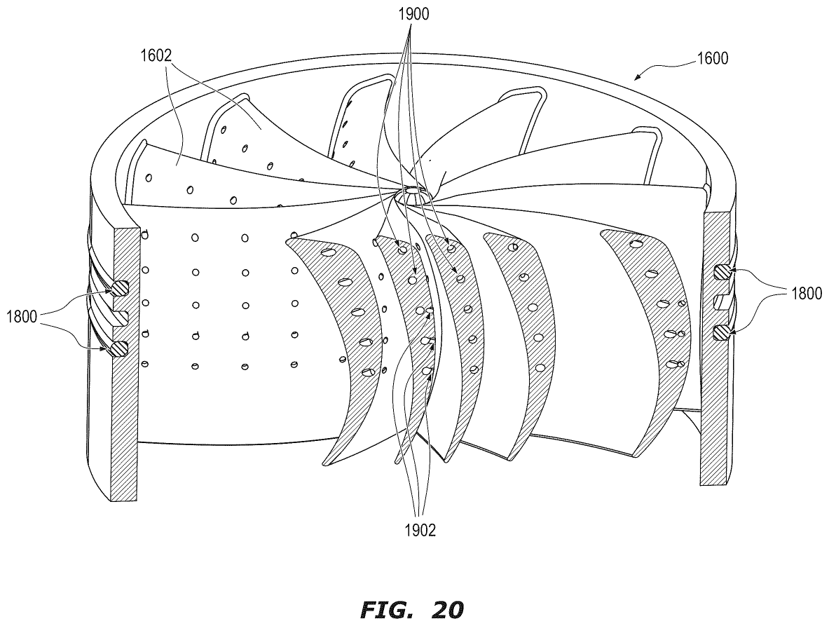

As shown in FIGS. 19-20, the fluid inlets 1804 are in fluid communication with the perforations 1604. In particular, the fluid inlets 1804 lead into airfoil channels 1900 (e.g., arteries, passageways, or fluid tunnels) that extend through the interior of the airfoils 1602. The airfoil channels 1900 then fluidly connect to capillaries 1902 for dispersing fluid through the perforations 1604.

Any of the features, components, and/or parts, including the arrangements and configurations thereof shown in FIGS. 16-20 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 16-20.

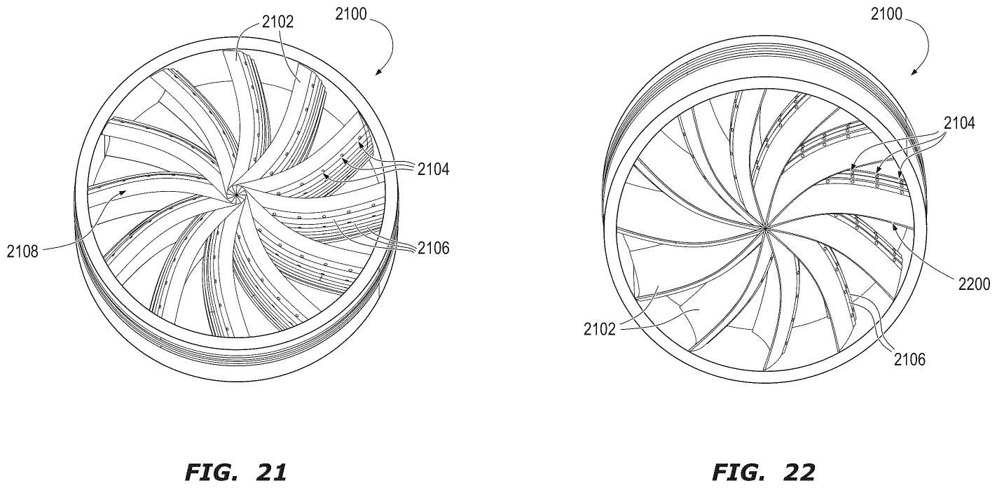

In some examples, a mixer device can include airfoils with wavelets, but without serrations. In accordance with one or more such examples, FIGS. 21-22 respectively illustrate front perspective and rear perspective views of a mixer device 2100. As shown, the mixer device 2100 can include airfoils 2102 having perforations 2104 and wavelets 2106 between a leading edge 2108 and a trailing edge 2200, similar to one or more examples previously described above. In these or other examples, a mixing event can occur as fluid is dispersed through the perforations 2104 and as oncoming fluid proceeds across the wavelets 2106, as similarly described above for the first mixing event in conjunction with FIG. 12.

Any of the features, components, and/or parts, including the arrangements and configurations thereof shown in FIGS. 21-22 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 21-22.

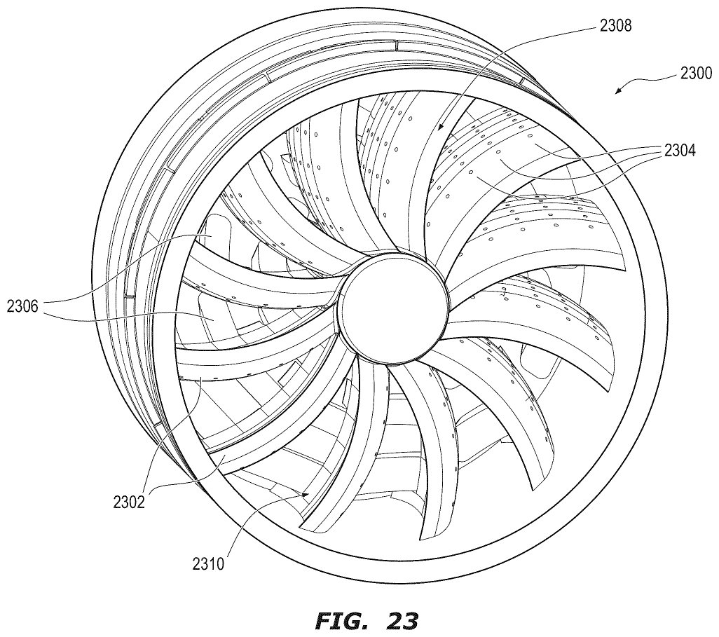

In some examples, a mixer device can include airfoils with serrations, but without wavelets. In accordance with one or more such examples, FIG. 23 illustrates an example mixer device 2300. As shown, the mixer device 2300 can include airfoils 2302 having perforations 2304 along the top major surface and serrations 2306 at a trailing edge 2310 opposite a leading edge 2308, similar to one or more examples previously described above. In these or other examples, a mixing event can occur as fluid engages the serration members, as similarly described above for the second mixing event in conjunction with FIG. 12.

Any of the features, components, and/or parts, including the arrangements and configurations thereof shown in FIG. 23 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 23.

As mentioned above, a housing of a mixer device can include a wide variety of shapes and sizes (e.g., based on fluid conditions, processing or mixing requirements, installation constraints, etc.). In some examples, a mixer device housing is non-circular. In these or other examples, the mixer device housing can be applied in non-pipe settings (e.g., open environment settings, a rectangular shaped channel, a box-shaped conduit, spillways, laboratory apparatuses, etc.). In accordance with one or more such examples, FIGS. 24-26 respectively illustrate front perspective, rear perspective, and cross-sectional views of a mixer device 2400.

As shown, the mixer device 2400 can include a housing 2402 having a rectangular shape that defines a main opening 2403 and an exit opening 2500. In addition, the mixer device 2400 can include airfoils 2404 having a lenticular shape with a leading edge 2410 and a trailing edge 2504. Both ends of the airfoils 2404 can be affixed to the housing 2402. The airfoils 2404 can also include airfoil surface perturbations 2406, 2502 (similar to the airfoil surface perturbations 308 and the airfoil surface perturbations 402 discussed above). Additionally, the airfoils 2404 can define perforations 2408 in one or more major surfaces of the airfoils 2404.

In particular examples, a second fluid can be dispersed through the perforations 2408 as oncoming fluid passes across the airfoils 2404. In these or other examples, the second fluid can be injected into the fluid inlet 2412, which is fluidly connected to an injection cavity 2602 enclosed by the housing 2402. By enclosing the injection cavity 2602, the mixer device 2400 can be implemented in a wide variety of environments without any need for the housing 2402 to sealingly engage a sidewall, a pipe wall, etc.

In some examples, injected fluid can pass from the injection cavity 2602 and into cavity inlets 2604 that fluidly connect to airfoil cavities 2600 defined by interior portions of each of the airfoils 2404. In this manner, injected (and pressurized) fluid can then exit the airfoil cavities 2600 and pass through the perforations 2408 to mix in with oncoming fluid passing over the airfoils 2404, as similarly described above.

Any of the features, components, and/or parts, including the arrangements and configurations thereof shown in FIGS. 24-26 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 24-26.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed.

It will be apparent to one of ordinary skill in the art that many modifications and variations are possible in view of the above teachings. Indeed, various inventions have been described herein with reference to certain specific aspects and examples. However, they will be recognized by those skilled in the art that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.” Additionally, the terms “about,” “approximately,” and “substantially” should be interpreted as +/−10 percent of a stated value.

What is claimed is:

1. A fluid mixer apparatus, comprising:
an annular ring defining a fluid flow path configured for a first fluid through the annular ring, the annular ring comprising one or more fluid inlets circumferentially disposed on an exterior surface of the annular ring, the one or more fluid inlets configured to receive a second fluid different than the first fluid;
a central hub; and
a plurality of helical airfoils positioned inside the annular ring and connected to both of the annular ring and the central hub, each helical airfoil of the plurality of helical airfoils comprising:
a plurality of perforations in fluid communication with the one or more fluid inlets to introduce the first fluid into the second fluid; and
an airfoil surface perturbation positioned adjacent to or rearward of the plurality of perforations.

2. The fluid mixer apparatus of claim 1, wherein the airfoil surface perturbation comprises a wavelet.

3. The fluid mixer apparatus of claim 2, wherein the wavelet extends from an inboard portion of the helical airfoil to an outboard portion of the helical airfoil.

4. The fluid mixer apparatus of claim 2, wherein the plurality of perforations extends along a length of the wavelet.

5. The fluid mixer apparatus of claim 2, wherein the wavelet is a first wavelet, and the airfoil surface perturbation comprises a second wavelet rearward of the first wavelet.

6. The fluid mixer apparatus of claim 1, wherein the airfoil surface perturbation comprises a plurality of serrations along a trailing edge of the helical airfoil.

7. The fluid mixer apparatus of claim 6, wherein the plurality of serrations comprises finger portions configured in alternating orientations relative to the trailing edge.

8. The fluid mixer apparatus of claim 6, wherein the plurality of serrations comprises at least one of different serration lengths or different serration angles along the trailing edge between an inboard portion of the helical airfoil and an outboard portion of the helical airfoil.

9. A stationary mixing device for mixing fluids, the stationary mixing device comprising:
a housing comprising one or more fluid inlets disposed on an exterior surface of the housing; and
a plurality of airfoils affixed to the housing, each airfoil of the plurality of airfoils comprising:
a leading edge;
a trailing edge positioned opposite of the leading edge;
a top surface and a bottom surface opposite the top surface, wherein:
the top surface and the bottom surface extend between the leading edge and the trailing edge; and
a fluid is configured to split at the leading edge such that a first fluid portion flows across the top surface at a first velocity and a second fluid portion is configured to flow across the bottom surface at a second velocity slower than the first velocity; and
a plurality of perforations defined by the top surface, the plurality of perforations in fluid communication with the one or more fluid inlets.

10. The stationary mixing device of claim 9, further comprising an airfoil surface perturbation positioned adjacent to or rearward of the plurality of perforations.

11. The stationary mixing device of claim 10, wherein:
the airfoil surface perturbation is a first airfoil surface perturbation positioned on the top surface; and
each airfoil of the plurality of airfoils comprises a second airfoil surface perturbation positioned along the trailing edge.

12. The stationary mixing device of claim 11, wherein:
the first airfoil surface perturbation is configured to induce a first mixing event before the trailing edge; and
the second airfoil surface perturbation is configured to induce a second mixing event after the trailing edge.

13. The stationary mixing device of claim 9, wherein each airfoil of the plurality of airfoils comprises an interior portion defining a cavity in fluid communication with the one or more fluid inlets and the plurality of perforations.

14. The stationary mixing device of claim 13, wherein the cavity is configured to be pressurized at a pressure that is greater than a fluid pressure at the top surface of the airfoil.

15. A fluid mixer apparatus, comprising:
a housing comprising a plurality of fluid inlets disposed on an exterior surface of the housing; and
a plurality of airfoils affixed to the housing, each airfoil of the plurality of airfoils comprising:
a major surface defining a plurality of perforations in fluid communication with the plurality of fluid inlets;
a wavelet positioned on the major surface and adjacent to the plurality of perforations; and
a trailing edge contiguous to the major surface, the trailing edge comprising a plurality of serrations.

16. The fluid mixer apparatus of claim 15, wherein the wavelet is configured to induce fluid recursion leading into the plurality of serrations.

17. The fluid mixer apparatus of claim 15, wherein the plurality of serrations is configured to cause interacting vortices.

18. The fluid mixer apparatus of claim 15, wherein the wavelet is a first wavelet, and a series of wavelets is positioned behind the first wavelet.

19. The fluid mixer apparatus of claim 15, wherein each serration of the plurality of serrations is pitched out-of-plane relative to the trailing edge.

20. The fluid mixer apparatus of claim 15, wherein the exterior surface defines an injection cavity positioned adjacent to the plurality of fluid inlets, the injection cavity separated from the plurality of fluid inlets by slotted ribs.
